(19) United States
(12) Patent Application Publication
(10) Pub. No.: US 2026/0236786 A1
(43) Pub. Date: Aug. 13, 2026

(54) TECHNIQUES FOR MODEL TRANSFER

(71) Applicant: Lenovo (United States) Inc., Morrisville, NC (US)

(72) Inventors: Venkata Srinivas Kothapalli, Aurora, IL (US); Ahmed Hindy, Aurora, IL (US); Vahid Pourahmadi, München (DE); Vijay Nangia, Woodridge, IL (US)

(21) Appl. No.: 19/052,190

(22) Filed: Feb. 12, 2025

(51) Int. Cl. G06N 3/096

(52) U.S. Cl. CPC G06N 3/096

(57) ABSTRACT

Various aspects of the present disclosure relate to training a neural network model based on a set of data samples; determining a set of model parameters associated with the trained neural network model, where one or more model parameters of the set of model parameters comprise at least a set of neural network weights; and transmitting, to a second wireless node, model generation information associated with the set of model parameters. The model generation information indicates a weights generator for generating the set of neural network weights and a set of weight indices corresponding to one or more weights selected from the set of neural network weights.

### TECHNICAL FIELD

The present disclosure relates to wireless communications, and more specifically to techniques for model transfer, for example, transferring one or more artificial intelligence or machine learning (AI/ML) models.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A first wireless node for wireless communication is described. In some examples, the first wireless node may implement, or may be implemented by, a UE or a NE. The first wireless node may be configured to, capable of, or operable to train a neural network model based on a set of data samples; determine a set of model parameters associated with the trained neural network model, where one or more model parameters of the set of model parameters comprise at least a set of neural network weights; and transmit—to a second wireless node-model generation information associated with the set of model parameters, where the model generation information indicates a weights generator for generating the set of neural network weights and a set of weight indices corresponding to one or more weights selected from the set of neural network weights.

A processor for wireless communication is described. In some examples, the processor may be implemented in a first wireless node, such as UE or a NE. The processor may be configured to, capable of, or operable to train a neural network model based on a set of data samples; determine a set of model parameters associated with the trained neural network model, where one or more model parameters of the set of model parameters comprise at least a set of neural network weights; and transmit—to a second wireless node-model generation information associated with the set of model parameters, where the model generation information indicates a weights generator for generating the set of neural network weights and a set of weight indices corresponding to one or more weights selected from the set of neural network weights.

A method performed or performable by a first wireless node for wireless communication is described. In some examples, the method may be implemented by a UE or a NE. The method may include training a neural network model based on a set of data samples; determining a set of model parameters associated with the trained neural network model, where one or more model parameters of the set of model parameters comprise at least a set of neural network weights; and transmitting—to a second wireless node-model generation information associated with the set of model parameters, where the model generation information indicates a weights generator for generating the set of neural network weights and a set of weight indices corresponding to one or more weights selected from the set of neural network weights.

A second wireless node for wireless communication is described. some examples, the second wireless node may implement, or may be implemented by, a UE or a NE. The second wireless node may be configured to, capable of, or operable to receive—from a first wireless node-model generation information associated with a set of model parameters, where the model generation information indicates a weights generator and a set of weight indices; generate a set of neural network weights based on the model generation information; and construct a neural network model, based on the set of neural network weights and the set of weight indices, where the set of weight indices corresponds to one or more weights selected from the set of neural network weights.

A processor for wireless communication is described. In some examples, the processor may be implemented in a second wireless node, such as UE or a NE. The second wireless node may be configured to, capable of, or operable to receive—from a first wireless node-model generation information associated with a set of model parameters, where the model generation information indicates a weights generator and a set of weight indices; generate a set of neural network weights based on the model generation information; and construct a neural network model, based on the set of neural network weights and the set of weight indices, where the set of weight indices corresponds to one or more weights selected from the set of neural network weights.

A method performed or performable by a second wireless node for wireless communication is described. In some examples, the method may be implemented by a UE or a NE. The method may include receiving—from a first wireless node-model generation information associated with a set of model parameters, wherein the model generation information indicates a weights generator and a set of weight indices; generating a set of neural network weights based on the model generation information; and constructing a neural network model, based on the set of neural network weights and the set of weight indices, wherein the set of weight indices corresponds to one or more weights selected from the set of neural network weights.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3 illustrates an example of a neural network, in accordance with aspects of the present disclosure.

FIG. 4 illustrates an example of a functional framework for AI/ML for a wireless interface, in accordance with aspects of the present disclosure.

FIG. 5 illustrates another example of a functional framework for AI/ML for the wireless interface, in accordance with aspects of the present disclosure.

FIG. 6 illustrates an example of a procedure for reporting performance monitoring results, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of a NE, in accordance with aspects of the present disclosure.

FIG. 10 illustrates a flowchart of a method performed by a first wireless node, in accordance with aspects of the present disclosure.

FIG. 11 illustrates a flowchart of a method performed by a second wireless node, in accordance with aspects of the present disclosure.

### DETAILED DESCRIPTION

Wireless communication systems beyond 5G may implement AI/ML positioning to improve the location estimate accuracy of a device (e.g., UE) in challenging radio conditions, such as environments with heavy non-line-of-sight (NLoS) conditions. One example of AI/ML positioning is the direct AI/ML positioning, where the output of the AI/ML model is or corresponds to a user's location (e.g., a user device position or UE's position). Another example of AI/ML positioning is the assisted AI/ML positioning, where the output is an enhanced positioning measurement with associated information such as an enhanced line-of-sight (LoS) or NLOS (LoS/NLOS) classification of the measurement as an output of the AI/ML model.

Wireless communication systems beyond 5G may implement AI/ML channel estimation to improve the accuracy of channel state information (CSI) corresponding to a channel between a device (e.g., UE) and a network node (e.g., base station or NE) particularly in environments with challenging radio conditions. One example of AI/ML enhanced channel estimation is the compression of CSI parameters in a CSI feedback report, where the output of the AI/ML model is the compressed CSI report. Another example of AI/ML enhanced channel estimation is the selection of a precoding matrix based on the CSI, where the output of the AI/ML model is the precoding matrix. Yet another example of AI/ML enhanced channel estimation is the selection of a beam from a codebook of beams, based on the CSI, where the output of the AI/ML model is the beam selection.

A trained AI/ML model may include a large number (e.g., thousands, tens of thousands, or hundreds of thousands) of parameters. Accordingly, transferring this large number of parameters to a wireless node (e.g., over a wireless channel) may result in a significant expenditure of time and energy, and may consume a large amount of the wireless bandwidth and network resources. The task of transferring the parameters of an AI/ML model, such as a deep neural network (DNN) model, from one device (e.g., wireless node) to another device (e.g., wireless node) is commonly referred to as “model transfer.”

Aspects of the present disclosure describe techniques for training AI/ML models, such as DNN models, and a framework for efficient model transfer of the trained AI/ML models to a wireless node, for example, without restricting the AI/ML models to be small in size (i.e., without restricting the number of model parameters) and without the need for quantizing the model parameters. Beneficially, the efficient model transfer described herein reduces the costs of model transfer (e.g., reduces the time, power requirements, network resources, etc.). Additionally, or alternatively, the efficient model transfer described herein allows for deployment of more complex AI/ML models at the wireless node.

A first solution describes a framework for training AI/ML models, such as DNN models, and uniquely characterizing the trained AI/ML models. In some examples, the AI/ML models may be trained by selecting an optimal value from a set of randomly generated candidate values. In some examples, the trained AI/ML models may be characterized by an encoding of the selected values and a description of the manner in which the candidate values were generated.

A second solution describes a framework for AI/ML model transfer to a wireless node, in which the unique characterization is transmitted to the wireless node in place of the model parameters corresponding to the trained AI/ML model, or in place of quantizing the model parameters corresponding to the trained AI/ML model and transferring the quantized parameters. Beneficially, receipt of the unique characterization allows the receiving wireless node to generate the same candidate values that were randomly generated at the training node, and then apply the same selection of optimal values without requiring the receiving wireless node to train the model or to receive the entire set of model parameters describing the trained AI/ML model.

While presented as distinct solutions, one or more of the solutions described herein may be implemented in combination with each other. Aspects of the present disclosure are described in the context of a wireless communications system.

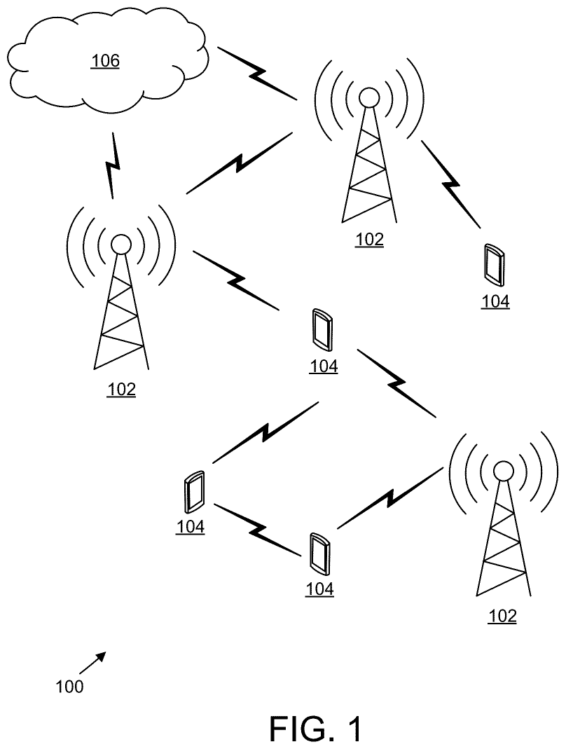

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHZ), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 KHz SCS.

According to implementations, one or more of the NEs 102 and the UEs 104 are operable to implement various aspects of the techniques described with reference to the present disclosure.

In some implementations, a first wireless node may train an AI/ML model based on a set of data samples. In some examples, the first wireless node may implement, or may be implemented by, the NE 102 or the UE 104. The AI/ML model may be a neural network model that comprises a plurality of neurons and a set of edges connecting the plurality of neurons. In some examples, to train the neural network model, the first wireless node selects a subset of neural network weights, i.e., corresponding to each neural layer of the neural network model.

The selection of a particular value (i.e., weight) may be based on whichever value/weight from a plurality of candidate values or candidate weights optimize an objective function, i.e., based on the set of data samples. Here, the objective function relates to the task(s) to be performed by the AI/ML model. Examples of different tasks to be performed in the wireless communication system 100 using AI/ML include, but are not limited to, beam prediction, CSI prediction, CSI compression, cell selection, cell re-selection, radio resource management (RRM) measurement prediction, measurement event prediction, positioning based on CSI, AI/ML based receiver, and the like.

Additionally, the first wireless node (e.g., NE 102 and/or UE 102) determines a set of model parameters that describe the trained AI/ML model. In addition to other parameters, the set of model parameters describing the trained AI/ML model includes at least a set of neural network weights. Based on the set of model parameters, the first wireless node determines model generation information, including at least a weights generator for generating the set of neural network weights, and a set of weight indices corresponding to one or more weights selected from the set of neural network weights.

Unlike known methods of model transfer, the first wireless node does not transfer the set of model parameters, nor a quantized version of the model parameters. Instead, the first wireless node transmits, i.e., to a second wireless node, the model generation information thereby enabling the second wireless node to independently generate the trained AI/ML model without transferring the full set of model parameters that describe the training AI/ML model and without requiring model training by the second wireless node.

Accordingly, the second wireless node receives the model generation information associated with a set of model parameters that defines a trained AI/ML model. In some examples, the second wireless node may implement, or may be implemented by, the NE 102 or the UE 104. Using the model generation information, the second wireless node generates a set of neural network weights based on the model generation information. As discussed above, the model generation information indicates a weights generator and a set of weight indices.

Further, the second wireless node reconstructs the trained AI/ML model (e.g., a neural network model) based on the set of neural network weights and the set of weight indices, wherein the set of weight indices corresponds to the weights selected by the first wireless node from the set of neural network weights, i.e., during the training of the AI/ML model.

Thereafter, the second wireless node may use the reconstructed AI/ML model to generate inferences and/or predictions for the task(s) to be performed by the AI/ML model. Beneficially, the second wireless node is able to independently generate/reconstruct the trained AI/ML model without having to perform training at the second wireless node and without requiring the transfer of the full set of model parameters that describe the training AI/ML model.

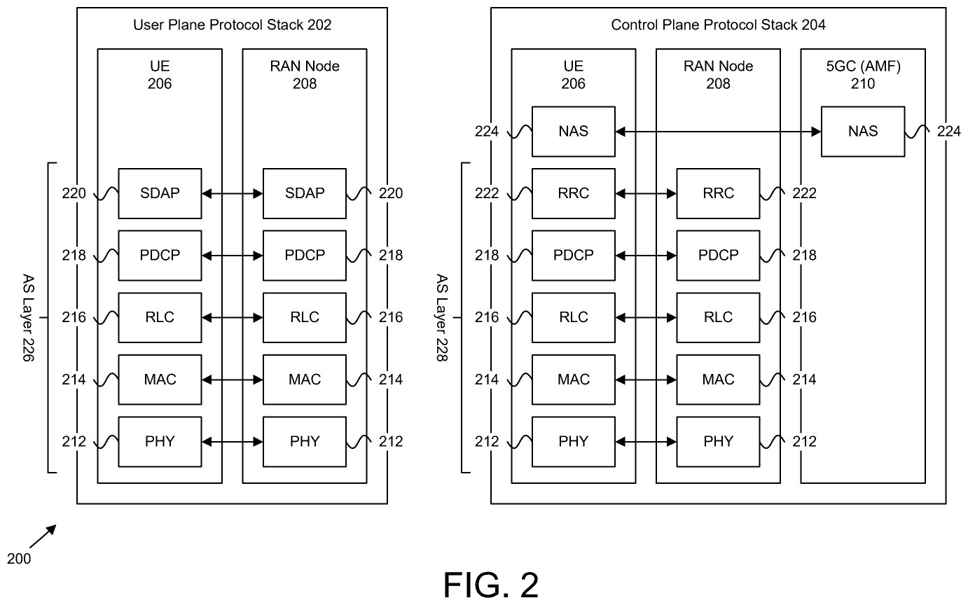

FIG. 2 illustrates an example of a protocol stack 200, in accordance with aspects of the present disclosure. While FIG. 2 shows a UE 206, a RAN node 208, and a 5GC 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a MAC sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, an RLC sublayer 216, and a PDCP sublayer 218. The Control Plane protocol stack 204 also includes a radio resource control (RRC) layer 222 and a non-access stratum (NAS) layer 224.

The AS layer 226 (also referred to as “AS protocol stack”) for the user plane protocol stack 202 consists of at least the SDAP sublayer 220, the PDCP sublayer 218, the RLC sublayer 216, the MAC sublayer 214, and the PHY layer 212. The AS layer 228 for the control plane protocol stack 204 consists of at least the RRC layer 222, the PDCP sublayer 218, the RLC sublayer 216, the MAC sublayer 214, and the PHY layer 212. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels (LCHs) to the RLC sublayer 216. The RLC sublayer 216 offers RLC channels to the PDCP sublayer 218.

The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation (CA) and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through LCHs. The MAC sublayer 214 therefore performs multiplexing and demultiplexing between LCHs and transport channels: the MAC sublayer 214 in the transmitting side constructs MAC PDUs (also known as transport blocks (TBs)) from MAC service data units (SDUs) received through LCHs, and the MAC sublayer 214 in the receiving side recovers MAC SDUs from MAC PDUs received through transport channels.

The MAC sublayer 214 provides a data transfer service for the RLC sublayer 216 through LCHs, which are either control LCHs which carry control data (e.g., RRC signaling) or traffic LCHs which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

The general procedure of developing an AI/ML model consists of minimizing a loss function based on a training data set that comprises of either labeled samples or unlabeled samples, resulting in supervised learning/training or unsupervised learning/training, respectively. The following definitions and descriptions provide a foundation for the generalization and adaptation of AI/ML models.

Regarding labeled data versus unlabeled data, when a data set contains both input samples and the corresponding output samples (i.e., labels), it is called a labeled data set. In contrast, when the data set contains only the input samples without the corresponding output samples/labels, it is called an unlabeled data set.

Let data samples

$${𝒟}_{tr} = {\{ ( {x}_{i} {y}_{i} ) \}}_{i = 1}^{n}$$

denotes the set of labelled training data samples, where x∈∈ [symbol] denotes an input sample and yᵢ∈ [symbol] denotes the corresponding label, or, equivalently, the desired output sample from the AI/ML model for input xᵢ. Here, xᵢ is a scalar or a one or multi-dimensional vector, and, similarly, yᵢ is a scalar or a one or multi-dimensional vector. Note that yᵢ is also known as the prediction/inference for input xᵢ. In unsupervised learning, the training data set would be an unlabeled data set

$${𝒟}_{tr} = {\{ ( {x}_{i} ) \}}_{i = 1}^{n} .$$

An AI/ML model is essentially a mapping or, a function, f_{w}, where f_{w}: [symbol] → [symbol] , and W denotes the set of optimal model parameters that are learned during the process of training the model. Determining the optimal values of model parameters (i.e., determining W using the data set [symbol] ) is referred to as the “training the model” or “learning the model.”

When yᵢ assumes finitely many values (i.e., when | [symbol] |, the cardinality of the set [symbol] is finite), then the AI/ML model is called a classifier model. When yᵢ assumes continuous values, i.e., when [symbol] ⊆ [symbol] and | [symbol] |=∞, then the AI/ML model is referred to as a regression model.

For the purpose of discussion, consider that the AI/ML model is a fully connected deep neural network (DNN), comprising of L layers with [symbol] number of neurons in layer [symbol] ∈{1, . . . , L}. Let

$${w}_{ij}^{( ℓ )}$$

denotes the weight of the edge connecting neuron j in layer [symbol] −1 with neuron i in layer [symbol] . The activation of neuron j in layer [symbol] , denoted by

$${A ( x )}_{j}^{( ℓ )} ,$$

is given by

$${A ( x )}_{j}^{( ℓ )} = V ( {\sum }_{u = 1}^{{n}_{ℓ - 1}} {A ( x )}_{μ}^{( ℓ - 1 )} {w}_{ij}^{( ℓ )} )$$

where V is a non-linear activation function and x denotes the input sample to the DNN.

The general procedure of supervised learning/training of a DNN consists of minimizing a loss function [symbol] with respect to a labelled training data set [symbol] . In other words, the optimal values of the edge weights

$${w}_{ij}^{( ℓ )} ,$$

i=1, . . . , [symbol] , j=1, . . . , [symbol] , with respect to a training data set [symbol] , are determined by minimizing a loss function using gradient descent and can be expressed as

$$W = {min}_{{W}^{′}} ℒ ( {W}^{′} , {𝒟}_{tr} )$$

[symbol] =1, . . . , L, i=1, . . . , [symbol] , j=1, . . . , [symbol] , denotes the set of optimal edge weights.

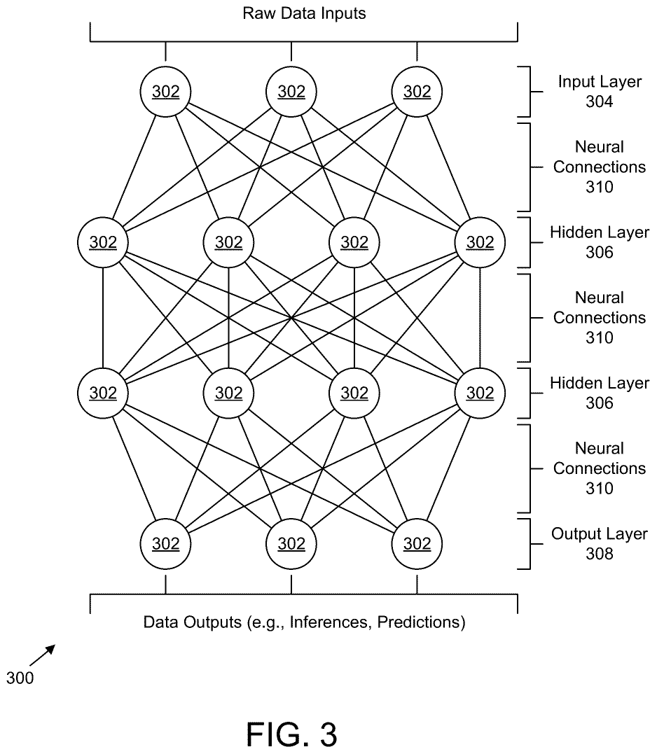

FIG. 3 illustrates an example of a neural network 300 (e.g., a DNN) for performing tasks in a wireless network, in accordance with aspects of the present disclosure. The neural network 300 comprises multiple layers of artificial neurons 302 that work together to analyze data, e.g., to recognize patterns and/or make predictions. A layer of artificial neurons 302 is referred to herein as a “neural layer.”

The neural network 300 comprises different types of neural layers including an input layer 304, one or more hidden layers 306, and an output layer 308. The input layer 304 receives the raw data (e.g., channel measurements, positioning measurements) and the output layer 308 produces the final result (also referred to as “model output”), such as a predictions or inferences relates to the performed task.

The hidden layers 306 (sometimes referred to as “intermediate layers”) process the input data by applying mathematical transformations via weighted connections between artificial neurons 302 of successive neural layers. While the example of FIG. 3 shows two hidden layers 306, for ease of illustration, in some examples the neural network 300 may include additional intermediate layers, e.g., to allow for more complex analysis leading to improved predictions or inferences.

As shown in FIG. 3, there are multiple neural connections 310 (e.g., edges) between the artificial neurons 302 of successive neural layers. Each artificial neuron 302 applies a weight (e.g., edge weight) to incoming data (e.g., either raw input data or data received from a preceding neural layer via a neural connection 310) and processes the weighted data using an activation function to determine whether to activate and produce a (non-zero) output.

data collection function 402 is a function that provides input data to the model training function 404, the management function 406, and the inference function 408. For example, the training data refers to data needed as input for the AI/ML model training function 404. In another example, the monitoring data refers to data needed as input for the management of AI/ML models or AI/ML functionalities. As yet another example, the inference data refers to data needed as input for the AI/ML inference function 408.

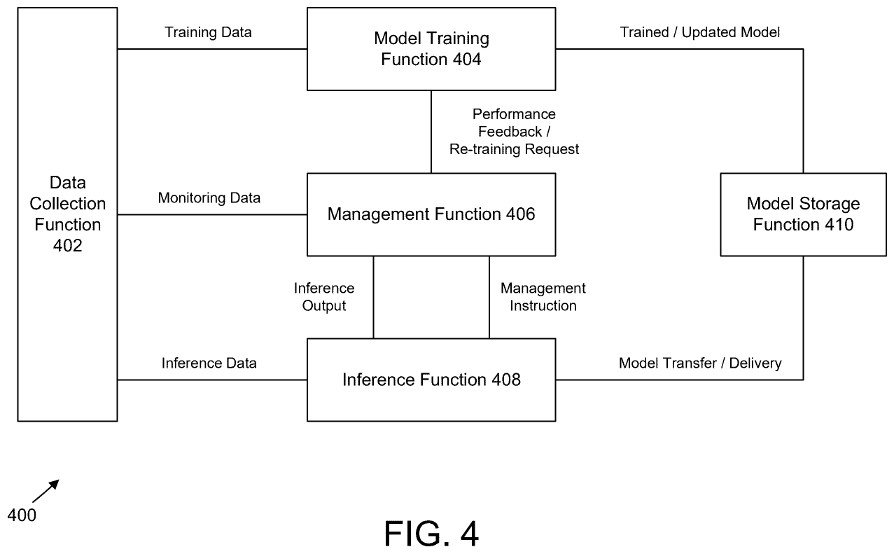

FIG. 4 illustrates an example of a functional framework 400 (i.e., a functional block diagram) for AI/ML for a wireless interface (e.g., an air interface), in accordance with aspects of the present disclosure. The general framework consists of multiple processes that enable AI/ML functionality over the wireless interface.

The data collection function 402 is a function that provides input data to the model training function 404, the management function 406, and the inference function 408. For example, the training data refers to data needed as input for the AI/ML model training function 404. In another example, the monitoring data refers to data needed as input for the management of AI/ML models or AI/ML functionalities. As yet another example, the inference data refers to data needed as input for the AI/ML inference function 408.

The model training function 404 is a function that performs AI/ML model training, validation, and testing which may generate model performance metrics which can be used as part of the model testing procedure. The model training function 404 is also responsible for data preparation (e.g., data pre-processing and cleaning, formatting, and transformation) based on training data delivered by a data collection function, if required.

For example, in the case of having a model storage function 410, the model training function 404 is used to deliver trained, validated, and tested AI/ML models to the model storage function 410, or to deliver an updated version of a model to the model storage function 410.

The management function 406 is a function that oversees the operation (e.g., selection/(de) activation/switching/fallback) and monitoring (e.g., performance) of AI/ML models or AI/ML functionalities. The management function 406 is also responsible for making decisions to ensure the proper inference operation based on data received from the data collection function 402 and the inference function 408.

The management instruction is an output of the management function 406. The management instruction refers to information needed as input to manage the inference function 408. Concerning information may include selection/(de) activation/switching of AI/ML models or AI/ML-based functionalities, fallback to non-AI/ML operation (i.e., not relying on inference process), etc.

The model transfer/delivery request is another output of the management function 406 used to request model(s) to the model storage function 410. The performance feedback/retraining request is another output of the management function 406 and refers to information needed as input for the model training function 404, e.g., for model (re) training or updating purposes.

The inference function 408 is a function that provides outputs from the process of applying AI/ML models or AI/ML functionalities, using the data that is provided by the data collection function 402 (i.e., inference data) as an input. The inference function 408 is also responsible for data preparation (e.g., data pre-processing and cleaning, formatting, and transformation) based on inference data delivered by a data collection function 402, if required.

The inference output is an output of the inference function 408 and refers to data used by the management function 406 to monitor the performance of AI/ML models or AI/ML functionalities. As noted above, during the inference stage, the inference function 408 applies AI/ML models or AI/ML functionalities (e.g., using the inference data) to produce the inference output.

The model storage function 410 is a function responsible for storing trained/updated models that can be used to perform the inference function 408. Note that the model storage function 410 may be a reference point when applicable for protocol terminations, model transfer/delivery, and related processes. It should be stressed that its purpose does not encompass restricting the actual storage locations of models. Therefore, the impact of all data/information/instruction flows may be evaluated on a case by case basis.

The model transfer/delivery is an output of the model storage function 410 and is used to deliver an AI/ML model to the Inference function 408.

In the case of positioning accuracy enhancements, the following are selected as representative sub-use cases: A) direct AI/ML positioning; and B) AI/ML assisted positioning.

For the case of direct AI/ML positioning, the AI/ML model outputs the UE location. One example of direct AI/ML positioning includes fingerprinting based on channel observation as the input of AI/ML model.

For the case of AI/ML assisted positioning, the AI/ML model outputs new measurement and/or enhancement of existing measurement. For example, the AI/ML model may output LoS/NLOS identification, timing and/or angle of measurement, or likelihood of measurement information.

The following use cases are relevant to the present disclosure: Case 1, characterized by UE-based positioning with UE-side model, direct AI/ML or AI/ML assisted positioning; Case 2a, characterized by UE-assisted and location management function (LMF)-based positioning with UE-side model, AI/ML assisted positioning; Case 2b, characterized by UE-assisted/LMF-based positioning with LMF-side model, direct AI/ML positioning; Case 3a, characterized by a next generation radio access network (NG-RAN) node assisted positioning with gNB-side model, AI/ML assisted positioning; and Case 3b, characterized by NG-RAN node assisted positioning with LMF-side model, direct AI/ML positioning.

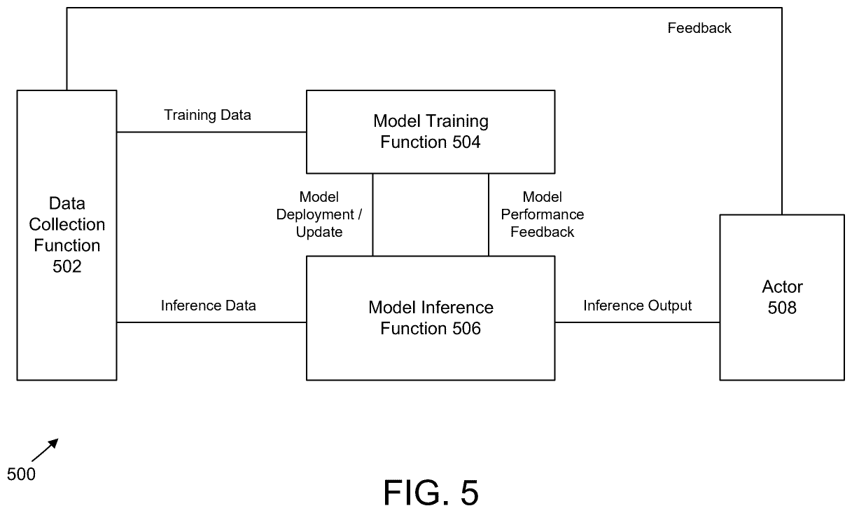

FIG. 5 illustrates another example of a functional framework 500 (i.e., a functional block diagram) for AI/ML for RAN intelligence, in accordance with aspects of the present disclosure. The general framework consists of multiple processes that enable AI/ML functionality over the wireless interface.

The data collection function 502 is a function that provides input data to the model training function 504 and the model inference function 506. AI/ML algorithm specific data preparation (e.g., data pre-processing and cleaning, formatting, and transformation) is not carried out in the data collection function 502. Examples of input data may include measurements from UEs or different network entities, feedback from the actor 508, and output from an AI/ML model.

The training data is an output of the data collection function 502 and refers to the data needed as input for the AI/ML model training function 504. The inference data is another output of the data collection function 502 and refers to the data needed as input for the AI/ML model inference function 506.

The model training function 504 is a function that performs the ML model training, validation, and testing which may generate model performance metrics as part of the model testing procedure. The model training function 504 is also responsible for data preparation (e.g., data pre-processing and cleaning, formatting, and transformation) based on training data delivered by a data collection function 502, if required.

The model deployment/update is an output of the model training function 504 which may be used to initially deploy a trained, validated, and tested AI/ML model to the model inference function 506, or to deliver an updated model to the model inference function 506.

The model inference function 506 is a function that provides AI/ML model inference output (e.g., predictions or decisions). In certain embodiments, the model inference function 506 provides model performance feedback to model training function 504. The model inference function 506 is also responsible for data preparation (e.g., data pre-processing and cleaning, formatting, and transformation) based on inference data delivered by a data collection function 502, if required.

The inference output of the AI/ML model produced by a model inference function 506 may be provided to the actor 508. The model performance feedback is an optional output of the model inference function 506 which may be used for monitoring the performance of the AI/ML model, when available.

The actor 508 is a function that receives the output from the model inference function 506 and triggers or performs corresponding actions. The actor 508 may trigger actions directed to other entities or to itself. Accordingly, the actor 508 may output feedback, i.e., information that may be needed to derive training data, inference data or to monitor the performance of the AI/ML model and its impact on the network through updating of key performance indicators (KPIs) and performance counters.

The development of powerful learning methods in the domain of AI/ML has led to the adoption of AI/ML techniques for building more efficient modules in the Tx-Rx chain of wireless communication systems. Several AI/ML models have been developed for performing various functions in wireless networks, and future wireless communication systems may replace the conventional non-AI/ML modules in the transceiver chain with AI/ML models developed through data driven methods. In particular, AI/ML models may be implemented for use cases in the physical layer including, CSI compression, beam prediction, and positioning.

The solutions described herein use the deep neural network (DNN) as the exemplary type of AI/ML model. However, the solutions described herein may also be extended to other types or architecture of AI/ML models, or a generic network with multiple neurons/nodes over a set of neural layers connected with a group of edges.

For each task, a DNN f_{w} is trained. The trained DNN models are to be available at the wireless nodes/devices which are to make inferences/predictions while working/operating in a wireless network, i.e., using the trained DNNs. Each wireless node can either be a network node (such as a gNB, or a network node responsible for determining the position based on the measurements reported by an edge node) or an edge node, such as a UE. For example, if the AI/ML model is a UE side model for assisting the UE to predict the best beam through the reference signal received power (RSRP) values the UE measures, then the DNN should be hosted by (or, deployed at) the UE.

With the development of more powerful learning methods, the training and testing/validation costs an AI/ML model increase, thereby demanding significant amounts of computational resources, energy/power supply, and sometimes larger amounts of memory than can be afforded by edge devices (e.g., UEs). Thus, in some implementations the training of an AI/ML model is done (offline and/or online) at a network node or at a centralized facility having an abundance of resources. Thereafter, the trained AI/ML models are transferred/transmitted to the other devices where the AI/ML models will be deployed.

However, as described above, transferring the trained AI/ML models to the nodes at which the AI/ML models are going to be deployed also results in a significant cost of network resources (bandwidth, energy, time etc.) as each model may be composed of tens or hundreds of thousands of model parameters that need to be sent reliably over the noisy wireless channel. When the AI/ML model (e.g., DNN model) is small, thus having a small number of parameters, then the amount of signaling required for model transfer is less than what is required for a larger AI/ML model. Though it is desirable to have small models, such small models are not powerful enough and do not offer desired levels of prediction/inference performance.

Conventional techniques for improving the efficiency of model transfer include the quantization of the AI/ML model parameters. Note that each parameter of a DNN model is a real-valued scalar and thus requires a large number of bits to represent the real-valued scalar in binary with a high precision. The required number of bits can be reduced by quantizing each parameter value. As used herein, quantizing a parameter refers to reducing the number of bits used to represent each parameter, e.g., by converting the high-precision floating-point values into lower-precision approximations, such as 16-bit values, 8-bit values, etc.

However, the quantization of the model parameters (i.e., those determined during training the AI/ML model), cause the parameter values to deviate from their optimal values and results in a loss of performance of the AI/ML model. Quantization of model parameters is useful as long as the loss in performance with parameter quantization is within tolerable limits; however, to reduce the number of bits required to represent the model parameters, one has to resort to a coarse quantization of the parameter values and there is a practical limit on how coarse of parameter quantization can be tolerated.

Another technique for improving the efficiency of model transfer includes data compression of the trained AI/ML model parameters. Here, the AI/ML model is trained without necessarily constraining its size and then compress techniques are applied to the developed model to reduce the amount of data needed for model transfer. Compression techniques to compress/reduce the model size may include techniques such as network pruning, knowledge distillation, and the like. However, model compression (through, for example, Kronecker factorization) is effective only to a limited extent in reducing the size of an AI/ML model.

Accordingly, the solutions described herein reduce the cost of model transfer without requiring the AI/ML models to be small in size (i.e., without limiting the number of model parameters, as such a restriction on the size of a model degrades inference and/or prediction performance) and without the need of quantizing the model parameters (as quantizing the model parameters might reduce the inference performance of the AI/ML model). Because the solutions described herein do not require any quantization of the parameters, the disclosed model transfer ensures the optimal performance of the AI/ML model (e.g., DNN model).

According to aspects of the first solution, the overhead in model transfer may be reduced based on training deep neural networks (DNNs) through the selection of random weights (SRW) technique. As discussed above, a DNN may comprise multiple artificial neurons and multiple edges connecting the neurons, with each edge (i.e., connection) having an edge weight. The architecture of the DNN (i.e., the number of neural layers, number of neurons in each neural layer, how the neurons between different neural layers are connected), along with the edge weights and the activation functions of the neurons specify the DNN.

In the paradigm of deep learning, the DNNs developed are often large networks comprising a large number of neurons (e.g., of the order of hundreds of artificial neurons under a conservative estimate) and a huge number of edges between those neurons (e.g., of the order of thousands of artificial neurons). Thus, the edge weights compose a major portion of the parameters that specify a DNN, and the fact that each edge weight is a real-valued scalar further increases the amount of signaling overhead required to convey the model parameters from one node/device to the other node/device.

Let L be the total number of neural layers in a DNN and let ne denotes the number of neurons in neural layer [symbol] ∈{1, . . . , L}. Let

$${w}_{ij}^{( ℓ )}$$

denotes the weight of the edge [symbol] connecting neuron j in neural layer [symbol] −1 with neuron i in neural layer [symbol] .

For each edge (i, j) (for brevity, the superscript denoting the neural layer ( [symbol] ) is omitted), generate a set of K random numbers {wᵢⱼ₁, . . . , w_{ijK}}, independently, from a probability distribution P_{w} and consider the generated K random numbers as K candidate values to be used as the weight for edge (i, j).

For each edge weight wᵢⱼₖ, k=1, . . . , K, let gᵢⱼₖ denotes the “goodness measure” (or “quality measure/score”), an indication of how good the weight wᵢⱼₖ is for the edge (i, j).

One among the K weights is selected based on gᵢⱼₖ, k=1, . . . , K as

$${k}^{*} = E ( {g}_{ij 1} , … , {g}_{ijK} )$$

where E: [symbol] → [symbol] is function that determines the index of the most suitable weight for the edge (i, j), denoted by k*, based on the K goodness measures (one for each of the weights) it is supplied with.

An example of the function E is the one which selects the suitable weight index as the one that corresponds to the maximum value of the goodness measure. Another example of E is a function that selects the suitable weight index probabilistically, where the probability of selecting an index k is proportional to the value of its goodness measure gᵢⱼₖ.

In one example, the function E may be common (or same) or all edges/connections in the AI/ML network. In another example, a first function E may be used for a first subset of the AI/ML network (e.g., a first subset of neural layers), and a second function E₂ may be used for a second subset of the AI/ML network (e.g., a second subset of neural layers).

The training (or developing) a DNN based on the SRW technique is equivalent to selecting the most suitable weight for each edge from a set of K random weights. Once a set of K random weights are generated for each edge in the DNN, the process of selecting a suitable weight boils down to determining the goodness measure of all the candidate weights for each edge in accordance with the available training data and selecting a weight based on the determined goodness measures.

Moreover, determining the goodness measure for the K candidate weights wᵢⱼ₁, . . . , w_{ijK} of an edge (i, j) is done through an iterative process, which involves minimizing an objective function based on the training data and is described as follows:

First, the goodness measures gᵢⱼₖ, k=1, . . . , K, are initialized by drawing random values (i.e., independently) from a probability distribution P_{g}.

Next, in the forward pass, for each edge, select one among the K weights using the function E and the current values of goodness measures of the edge weights.

Then, in the backward pass, for each edge, update the goodness measure of all the K weights, by computing the gradient of the loss function with respect to the current values of the goodness measures. The update in the goodness of measure

$${g}_{ijk}^{( ℓ )}$$

for the weight

$${w}_{ij}^{( ℓ )}$$

during the backward pass is given by:

$${g}_{ijk}^{( ℓ )} ← {g}_{ijk}^{( ℓ )} - α {Δ}_{{g}_{ijk}^{( ℓ )}}$$

$$where ,$$

$${∇}_{{g}_{ijk}^{( ℓ )}} = \frac{\partial ℒ}{\partial {\tilde{A} ( x )}_{i}^{( ℓ )}} {A ( x )}_{j}^{( ℓ - 1 )} {w}_{ijk}^{( ℓ )} .$$

In the above equations, x represents the input sample; [symbol] represents the loss function;

$${\tilde{A} ( x )}_{i}^{( ℓ )}$$

represent the pre-activation of neuron i in neural layer [symbol] , and

$${A ( x )}_{j}^{( ℓ - 1 )}$$

represents the activation of neuron j in neural layer [symbol] −1.

By following the above iterative learning procedure, the goodness measures

$$\{ {g}_{ij}^{( ℓ )} \} ,$$

[symbol]

=1, . . . , L, l=1, . . . , [symbol] , j=1, . . . , [symbol] , are updated, leading to selecting the optimal weight out of the K candidate weights (using the function E) for each edge/connection/link in the DNN.

Note that the techniques for reducing the signaling overhead for model transfer, described below, assume that the DNN model is developed using the SRW technique.

In some implementations of the first solution, there may be a design tradeoff between a number of neural layers L and an average number of neurons per neural layer

$$N {=}^{Δ} \frac{1}{L} {\sum }_{ℓ = 1}^{L} {n}_{ℓ}$$

on one hand, and a number of random weights K on the other hand. In one example, if the product of L and N values (i.e., a value of L₁N₁) for a first DNN exceeds a threshold value, then the first DNN is configured with a first number of random weights, e.g., K₁. In another example, if the product of L and N values (i.e., a value of L₂N₂) for a second DNN is smaller than the threshold value, then the second DNN is configured with a second number of random weights, e.g., K₂, wherein the first number of random weights is smaller than the second number of random weights, i.e., K₁<K₂.

In some examples, a first number of random weights K₁ may be used for a first subset of the DNN (e.g., a first subset of neural layers), and a second number of random weights K₂ may be used for a second subset of the AI/ML network (e.g., a second subset of neural layers).

In some implementations of the first solution, the DNN model is trained to enable a derivation of CSI corresponding to a channel between a UE node and a network node in the form of a concise feedback size, the CSI corresponding to one of a selection of a precoding matrix, a selection of a beam from a codebook of beams, or a combination thereof.

In some other implementations of the first solution, the DNN model is trained to enable a determination of a location or position of a device node.

Note that the selection of a first set of weights may depend on variations in the environment comprising the link between the UE and the network node (e.g., NE or base station), a speed of the UE, a channel state of the UE node, whether the UE is in LoS or NLOS with the network node, or a combination thereof.

According to aspects of a second solution, the trained DNN model may be uniquely characterized (i.e., defined or specified) by the following information: A) the number of neural layers L; B) the number of neurons in each neural layer [symbol] , for [symbol] =1, . . . , L; C) the activation functions of the neurons A(x); D) the connectivity between the neurons belonging to successive neural layers, i.e., whether the edge (i, j) exists for the i^{th} neuron in neural layer [symbol] (for [symbol] =2, . . . , L, i=1 . . . , [symbol] ), and the j^{th} neuron in neural layer [symbol] −1 (for [symbol] =2, . . . , L, j=1 . . . , [symbol] ); and E) weights of all the edges between neurons belonging to every successive pair of neural layers:

$$W = \{ {w}_{ij}^{( ℓ )} \} ,$$

[symbol]

=1, . . . , L, i=1, . . . , [symbol] , j=1, . . . , [symbol] .

It can be observed that the signaling required for conveying the edge weights, i.e., signaling for (E), is the dominant/major fraction of the total signaling required for model transfer.

Signaling corresponding to (A), (B), (C) and (D) is required in the existing methods of model transfer as well as in the enhanced method of model transfer proposed in the present disclosure. However, the proposed method enables an efficient way of transferring knowledge of the edge weights

$$( W = \{ {w}_{ij}^{( ℓ )} \} ,$$

[symbol]

=1, . . . , L, i=1, . . . , [symbol] , j=1, . . . , [symbol] ), thereby significantly reducing the signaling corresponding to (E).

When the DNN is developed using SRW technique, the edge weights of the DNN can be uniquely reproduced by transmitting the following information in place of the weights of all the edges between neurons belonging to every successive pair of neural layers. In other words, the information to be sent corresponding to (E), when the DNN is trained through SRW technique, is the following information: E1) the probability distribution P_{w} from which the K random weights for each edge are drawn; E2) the value of K; E3) the “seed” or initialization value for the pseudo-random number generator that generates random samples from the probability distribution P_{w} (note that the seed can be a positive integer); and E4) index of the optimal weight (i.e., k* ∈{1, . . . , K}) for each edge. A significant reduction of the overhead and resources required for model transfer is achieved as the information regarding (E1), (E2), (E3), (E4) is significantly less that the information regarding (E), i.e., the weights of all the edges between neurons belonging to every successive pair of neural layers.

As discussed above, it is assumed that a DNN, based on the SRW technique, is developed/trained at a first wireless node or at a vendor's or centralized facility/laboratory, referred to as the “Tx-node” for the purpose of discussion. The Tx-node transmits/sends information corresponding to (A), (B), (C), (D) and (E1), (E2), (E3), (E4) to a second wireless node, which is referred to as the “Rx-node” for continuing with our discussion. Note that the Rx-node is the device where the DNN is supposed to be employed/deployed in a wireless network. When the Rx-node receives information regarding (A), (B), (C), (D) and (E1), (E2), (E3), (E4) it would be able to uniquely construct the DNN at its end as explained below.

From the information corresponding to (A), (B), (C), and (D), the Rx-node can reproduce or re-construct the untrained DNN having the same architecture as that of the DNN model developed/trained at the Tx-node, including having the same neuron activation functions. However, the Rx-node still needs to assign the weights to the edges of its DNN, e.g., as determined during the model training.

Accordingly, the Rx-node reproduces the edge weights corresponding to the trained DNN model using information (E1), (E2), (E3), and (E4). In one example, Rx-node generates K random weights from the probability distribution P_{w} (or, equivalently, the pseudo-random generator that generates random values according to the probability distribution P_{w}) for each edge using the “seed.” Then, using the received index of the optimal weight for each edge, Rx-node selects only one weight for each edge from the generated K random weights in the above step.

In another example, Rx-node generates the weight for each edge based on the pseudo-random generator that generates random values (e.g., according to the probability distribution P_{w}), the initial pseudo-random generator seed/initialization, and the index of the optimal weight for each edge. To generate the weight for an edge, the Rx-node may generate an offset mask to the initial pseudo-random generator seed/initialization based on the index of the optimal weight for that edge that results in the generation of the weight for that edge.

By assigning weights to each edge in the DNN, the Rx-node reproduces (i.e., recreates) the DNN at its end. Thus, the Tx-node and the Rx-node successfully complete the task of model transfer.

As stated previously, in order to transfer/send edge weights from one node/device to the other node/device, the information regarding (E1) to (E4) needs to be transmitted from the Tx-node (i.e., first wireless node) to the Rx-node (i.e., second wireless node). Note that in the following discussion, the notation ┌z┐ indicates a smallest integer greater than or equal to z.

Regarding the information (E1), the probability distribution P_{w} from which the K random weights for each edge are drawn is communicated from Tx-node to Rx-node. In one example, a set of probability distribution parameters are pre-configured at both nodes/devices (e.g., specified in technical specifications), wherein the number of the elements of the set is a finite value P. A number of bits needed to identify a selected probability distribution is then ┌log₂ P┐ bits.

In some other examples, each neural layer is associated with a distinct probability distribution selected from the pre-configured set of probability distribution parameters, requiring the signaling of L·┌log₂ P┐ bits, where L represents the number of neural layers in the DNN.

Regarding the information (E2), the value of K is communicated from Tx-node to Rx-node. In general, the K weight values are indexed from 1 to K. In one example, value of K is same for all the neural layers in the neural network, it requires ┌log₂ K┐ bits to transmit/send the value of K. In another example, value of K is taken from a finite set of N possible values, requiring ┌log₂ N_{K}┐ bits when the value of K is same for all the neural layers in the neural network.

In some examples, a value K is layer-specific, i.e., all the edges to neural layer [symbol] (from neural layer [symbol] −1) might have [symbol] candidate weights, thereby requiring

$${\sum }_{ℓ = 1}^{L} ⌈ {log}_{2} {K}_{ℓ} ⌉$$

bits. In one example, the value of [symbol] is taken from a finite set of N_{K} possible values, thereby requiring

$${\sum }_{ℓ = 1}^{L} ⌈ {log}_{2} {N}_{K} ⌉ = L \cdot ⌈ {log}_{2} {N}_{K} ⌉$$

bits.

In some examples, a value K is layer-group-specific or for a subset of neural layers, i.e., each layer-group/subset of neural layers K value (Kⱼ candidate weights for j=1, . . . , N_{g}, where N_{g} is the number of layer-groups/subsets) requires ┌log₂ Kⱼ┐ bits which requires in all

$$⌈ {log}_{2} {N}_{g} ⌉ + {\sum }_{j = 1}^{{N}_{g}} ⌈ {log}_{2} {K}_{j} ⌉$$

bits. In one example, the value of [symbol] is taken from a finite set of N_{K} possible values, thereby requiring ┌log₂ N_{g}┐+N_{g}·┌log₂ N_{K}┐ bits.

Regarding the information (E3), the “Seed” for the random number generator that generates random samples from the probability distribution P_{w} is communicated from Tx-node to Rx-node. In some examples, the seed can be a positive integer. Assuming that seed is an integer between 0 and an integer Nₛ−1, it requires ┌log₂ Nₛ┐ bits.

Note that the reported seed may not necessarily be the actual seed per edge and may instead correspond to a base seed or a common component value for all seeds. In one example, assuming a total number of Eₜ edges in the DNN, indexed from 0 to Eₜ−1, and the K weight values indexed from 0 to K−1, the actual seed value used for a selected weight value index of k and an edge e is Nₛ+K·e+k.

In some examples, the K candidate random weights may be the same for all edges in the neural network. In another example, the K candidate random weights may be the same for all edges in a neural layer or subset of neural layers. A first set of K candidate random weights may be used for a first neural layer (or subset of neural layers), and a second set of K candidate random weights may be used for a second neural layer (or subset of neural layers).

Regarding the information (E3), the index of the optimal weight (i.e., k*∈{1, . . . , K}) for each edge is communicated from Tx-node to Rx-node. As the optimal weight index belongs to the set {1, . . . , K}, it requires ┌log₂ (K)┐ bits to send/transmit the index of the optimal weight.

Note that in the absence of any information of dependence of mutual weight values across edges, reporting optimal weights for all Eₜ edges requires Eₜ·┌log₂ (K)┐ bits, whereas if a correlation or dependence of weight values across edges is present, a fewer number of bits than Eₜ·┌log₂ (K)┐ bits are needed to signal the optimal weights across edges.

In some examples, a function G may determine the set of suitable weight indices for a plurality of edges (e.g., edges of a neural layer [symbol] ∈{1, . . . , L}). In one example, the function G may be based on a pseudo-random sequence generator (e.g., defined by a Gold sequence) which for a given seed/initialization value (cᵢₙᵢₜ) generates a weight index for each edge of the plurality of edges. The Tx-node may determine the initialization value (or index of the initialization value) from a plurality of initialization values that results in the pseudo-random generator to generate a sequence of weight index for the plurality of edges. The sequence of weight index may be identical or close (e.g., according to some metric such as L1 norm) to the optimal (independent selection for each edge) weight index sequence for the plurality of edges.

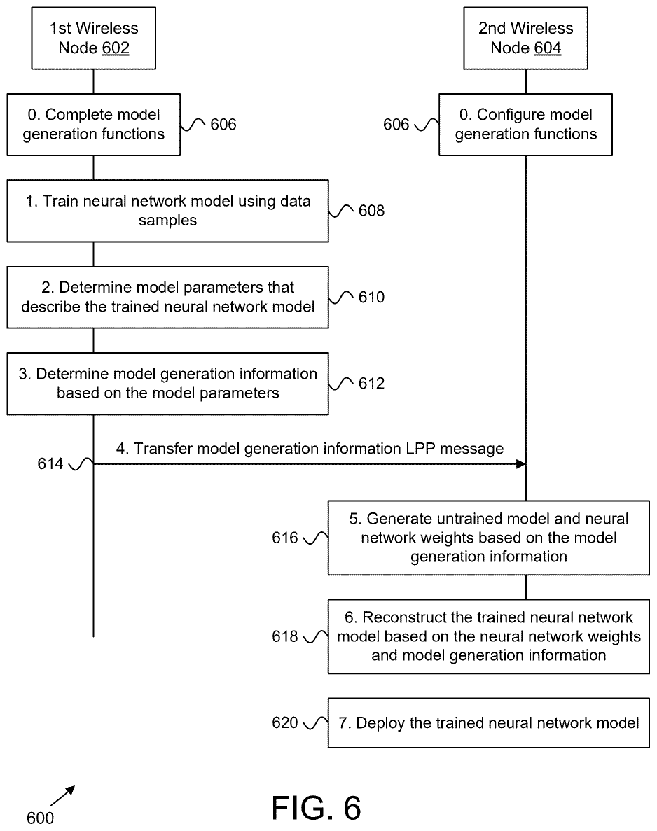

FIG. 6 illustrates an example of a procedure 600 for transferring and deploying a trained DNN model, in accordance with aspects of the present disclosure. The procedure 600 may implement or be implemented by aspects of the wireless communication system 100, or may implement or be implemented by aspects of the protocol stack 200. For example, the procedure 600 may be performed between a first wireless node 602, which may be examples of the NE 102 or the UE 104, and a second wireless node 604, which also may be examples of the NE 102 or the UE 104, as described herein.

In various implementations, the first wireless node 602 may train and transfer an AI/ML model to the second wireless node 604, where the AI/ML model may be used for one or more of: CSI prediction, CSI compression, mobility enhancements including cell selection and cell re-selection, RRM measurement prediction, measurement event prediction, positioning based on CSI, AI/ML-based receiver, or the like. The steps of the procedure 600 are described as follows:

At step 0, the first wireless node 602 and the second wireless node 604 may be configured with one or more model generation functions, such as random number generator functions, probability distribution functions, and/or activation functions (see block 606). These functions may be used to construct an untrained neural network model (e.g., DNN) and to generate candidate weights for SRW training of the neural network model.

At step 1, the first wireless node 602 may train a neural network model based on a set of data samples (see block 608). In some examples, the first wireless node 602 may implement, or may be implemented by, the NE 102 or the UE 104. The AI/ML model may be a neural network model that comprises a plurality of neurons and a set of edges connecting the plurality of neurons.

In some examples, to train the neural network model, the first wireless node selects a subset of neural network weights, i.e., corresponding to each neural layer of the neural network model. The selection of a particular value (i.e., weight) may be based on whichever value/weight from a plurality of candidate values or candidate weights minimize a loss function, i.e., based on the set of data samples.

At step 2, the first wireless node 602 may determine a set of model parameters that describe the trained neural network model (see block 610). Here, the set of model parameters describing the trained neural network model includes at least a set of neural network weights (e.g., edge weights).

At step 3, based on the set of model parameters, the first wireless node 602 determines model generation information based on the set of model parameters (see block 612). Here, the model generation information includes at least a weights generator for generating the set of neural network weights, and a set of weight indices corresponding to one or more weights selected from the set of neural network weights. In one implementation, weights generator may include a random number generator (e.g., configured in step 0). In another implementation, weights generator may include a probability distribution (e.g., configured in step 0). In certain implementations, the model generation information may also include a number of (random) candidate weights for each neural layer, and a seed or initialization value for the weights generator.

At step 4, the first wireless node 602 transmits, i.e., to a second wireless node 604, the model generation information (see messaging 614). Unlike conventional techniques, the procedure 600 does not involve any quantization of the model parameters, which might cause a degradation in the model performance. Also unlike conventional techniques, the procedure 600 does not require compressing the model or pruning the model to reduce the number of model parameters to achieve low signaling overhead.

At step 5, the second wireless node 604 generates an untrained neural network model and a set of neural network weights based on the model generation information (see block 616). As discussed above, the model generation information indicates a weights generator and a set of weight indices corresponding to the weights selected by the first wireless node 602 (e.g., from the set of neural network weights) during the training of the neural network model.

At step 6, the second wireless node 604 reconstructs the trained neural network model based on the set of neural network weights and the set of weight indices (see block 618). Beneficially, the second wireless node is able to independently generate/reconstruct the trained neural network model without having to perform training at the second wireless node and without requiring the transfer of the full set of model parameters that describe the training neural network model.

At step 7, the second wireless node 604 deploys the trained neural network model (see block 620), i.e., to perform AI/ML-assisted tasks such as CSI prediction, CSI compression, mobility enhancements including cell selection and cell re-selection, RRM measurement prediction, measurement event prediction, positioning based on CSI, AI/ML-based receiver, or the like. Because the second wireless node 604 reconstructs the trained neural network model first defined by the first wireless node 602, the performance and/or accuracy of the deployed DNN is not sacrificed in any manner to achieve the lower signaling overhead for model transfer.

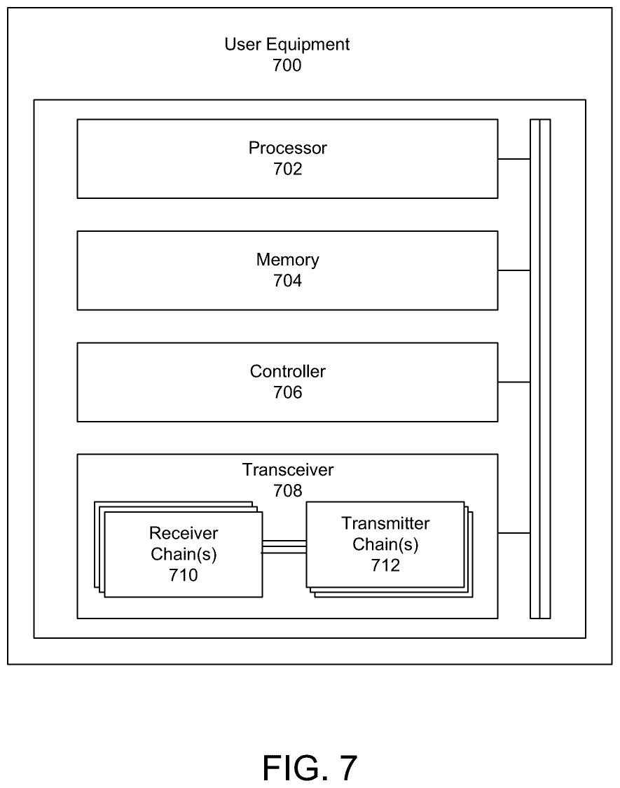

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform various functions (e.g., operations, signaling) described herein (e.g., executing, by the processor 702, instructions stored in the memory 704). In some implementations, the processor 702 may include multiple processors and the memory 704 may include multiple memories. One or more of the multiple processors may be coupled with one or more of the multiple memories, which may be individually or collectively, configured to perform various functions (e.g., operations, signaling) of the UE 700 as described herein.

In some implementations, the processor 702 and the memory 704 coupled with the processor 702 may be configured to cause the UE 700 to perform various functions (e.g., operations, signaling) of a first wireless node. For example, the processor 702 coupled with the memory 704 may be configured to, capable of, or operable to cause the UE 700 to train a neural network model based on a set of data samples; determine a set of model parameters associated with the trained neural network model, where one or more model parameters of the set of model parameters comprise at least a set of neural network weights; and transmit (i.e., to a second wireless node) model generation information associated with the set of model parameters, where the model generation information indicates a weights generator for generating the set of neural network weights and a set of weight indices corresponding to one or more weights selected from the set of neural network weights.

In some implementations, the weights generator includes a random number generator or a probability distribution. In such implementations, the model generation information may further indicate a number of candidate weights in the set of neural network weights, one or more parameters of the probability distribution, or an initialization value for the random number generator, or a combination thereof.

In some implementations, the neural network model includes a plurality of neural layers, each neural layer including one or more neurons of a plurality of neurons, where each edge in a set of edges connects a respective neuron in one neural layer with another neuron in a successive neural layer. In such implementations, the neural network model comprises the plurality of neurons and the set of edges connecting the plurality of neurons.

In some implementations, to train the neural network model, the processor 702 coupled with the memory 704 may be configured to, capable of, or operable to cause the UE 700 to select a first subset of the set of neural network weights, where the first subset corresponds to a first neural layer of the neural network model. In such implementations, the set of weight indices comprises indices corresponding to the selected first subset of the set of neural network weights.

In certain implementations, to train the neural network model, the processor 702 coupled with the memory 704 may be further configured to, capable of, or operable to cause the UE 700 to select a second subset of the set of neural network weights, where the second subset corresponding to a second neural layer of the neural network model. In such implementations, the set of weight indices further comprises indices corresponding to the selected second subset of the set of neural network weights.

In some further implementations, the first subset of the set of neural network weights is selected from a first set of candidate weight values associated with the first neural layer of the neural network model, and the second subset of the set of neural network weights is selected from a second set of candidate weight values associated with the second neural layer of the neural network model. In such implementations, the first set of candidate weight values and the second set of candidate weight values are based on the weight generator.

In certain implementations, the model generation information further indicates a first number of candidate weights in the first set of candidate weight values and a second number of candidate weights in the second set of candidate weight values. In certain implementations, the first number of candidate weights is different than the second number of candidate weights.

In some implementations, to train the neural network model, the processor 702 coupled with the memory 704 may be further configured to, capable of, or operable to cause the UE 700 to optimize an objective function based on the set of data samples.

In some implementations, the processor 702 coupled with the memory 704 may be configured to, capable of, or operable to cause the UE 700 to receive the set of data samples from the second wireless node or a third wireless node.

In some implementations, the processor 702 coupled with the memory 704 may be configured to, capable of, or operable to cause the UE 700 to determine the set of data samples based on one or more signals received from the second wireless node or a third wireless node.

Additionally, or alternatively, in some other implementations, the processor 702 and the memory 704 coupled with the processor 702 may be configured to cause the UE 700 to perform various functions (e.g., operations, signaling) of a second wireless node, in accordance with examples as disclosed herein. For example, the processor 702 coupled with the memory 704 may be configured to, capable of, or operable to cause the UE 700 to receive (i.e., from a first wireless node) model generation information associated with a set of model parameters, where the model generation information indicates a weights generator and a set of weight indices; generate a set of neural network weights based on the model generation information; and construct a neural network model, based on the set of neural network weights and the set of weight indices, where the set of weight indices corresponds to one or more weights selected from the set of neural network weights.

In some implementations, the processor 702 coupled with the memory 704 may be configured to, capable of, or operable to cause the UE 700 to determine a first subset of the set of neural network weights corresponding to weight selections for a first neural layer of the neural network model. In such implementations, the set of weight indices further comprises indices corresponding to the first subset of the set of neural network weights.

In certain implementations, the processor 702 coupled with the memory 704 may be configured to, capable of, or operable to cause the UE 700 to determine a second subset of the set of neural network weights corresponding to weight selections for a second neural layer of the neural network model. In such implementations, the set of weight indices further comprises indices corresponding to the second subset of the set of neural network weights.

In some further implementations, to construct the neural network model, the processor 702 coupled with the memory 704 may be configured to, capable of, or operable to cause the UE 700 to determine a first weight from the first subset of the set of weights based on the model generation information, the set of weight indices, and a number of candidate weights for the first set of candidate weight values.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

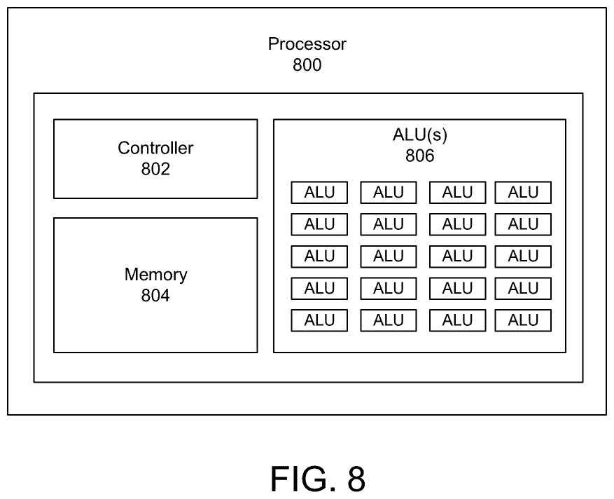

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1, or L2, or L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In some implementations, the processor 800 may support various functions (e.g., operations, signaling) of a first wireless node, in accordance with examples as disclosed herein. For example, the controller 802 coupled with the memory 804 may be configured to, capable of, or operable to cause the processor 800 to train a neural network model based on a set of data samples; determine a set of model parameters associated with the trained neural network model, where one or more model parameters of the set of model parameters comprise at least a set of neural network weights; and transmit—to a second wireless node-model generation information associated with the set of model parameters, where the model generation information indicates a weights generator for generating the set of neural network weights and a set of weight indices corresponding to one or more weights selected from the set of neural network weights. Additionally, the controller 802 coupled with the memory 804 may be configured to, capable of, or operable to cause the processor 800 to perform one or more functions (e.g., operations, signaling) of the first wireless node (e.g., a UE or NE) as described herein.

Additionally, or alternatively, in some other implementations, the processor 800 may support various functions (e.g., operations, signaling) of a second wireless node, in accordance with examples as disclosed herein. For example, the controller 802 coupled with the memory 804 may be configured to, capable of, or operable to cause the processor 800 to receive—from a first wireless node-model generation information associated with a set of model parameters, where the model generation information indicates a weights generator and a set of weight indices; generate a set of neural network weights based on the model generation information; and construct a neural network model, based on the set of neural network weights and the set of weight indices, where the set of weight indices corresponds to one or more weights selected from the set of neural network weights. Additionally, the controller 802 coupled with the memory 804 may be configured to, capable of, or operable to cause the processor 800 to perform one or more functions (e.g., operations, signaling) of the second wireless node as described herein.

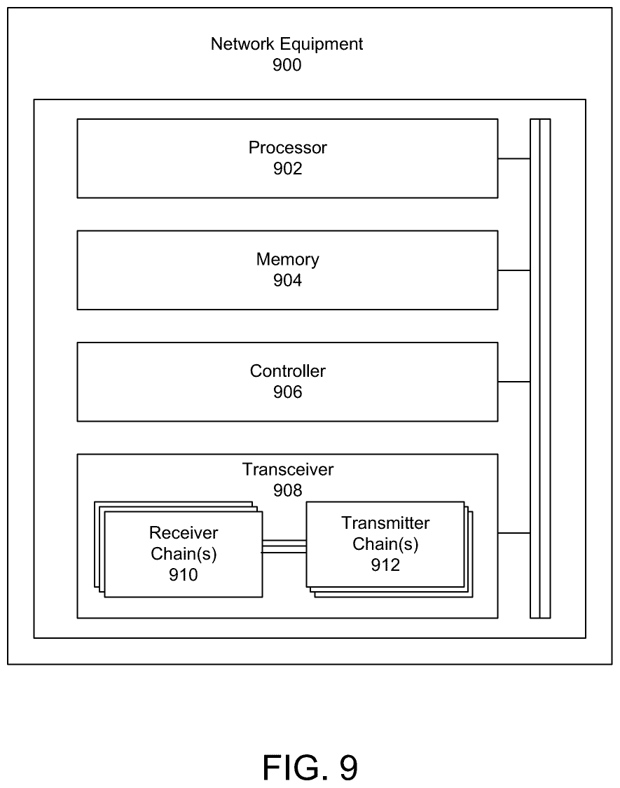

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the NE 900 as described herein.

In some implementations, the processor 902 and the memory 904 coupled with the processor 902 may be configured to cause the NE 900 to perform various functions (e.g., operations, signaling) of a first wireless node. For example, the processor 902 coupled with the memory 904 may be configured to, capable of, or operable to cause the NE 900 to train a neural network model based on a set of data samples; determine a set of model parameters associated with the trained neural network model, where one or more model parameters of the set of model parameters comprise at least a set of neural network weights; and transmit (i.e., to a second wireless node) model generation information associated with the set of model parameters, where the model generation information indicates a weights generator for generating the set of neural network weights and a set of weight indices corresponding to one or more weights selected from the set of neural network weights.

In some implementations, the weights generator includes a random number generator or a probability distribution. In such implementations, the model generation information may further indicate a number of candidate weights in the set of neural network weights, one or more parameters of the probability distribution, or an initialization value for the random number generator, or a combination thereof.

In some implementations, the neural network model includes a plurality of neural layers, each neural layer including one or more neurons of a plurality of neurons, where each edge in a set of edges connects a respective neuron in one neural layer with another neuron in a successive neural layer. In such implementations, the neural network model comprises the plurality of neurons and the set of edges connecting the plurality of neurons.

In some implementations, to train the neural network model, the processor 902 coupled with the memory 904 may be configured to, capable of, or operable to cause the NE 900 to select a first subset of the set of neural network weights, where the first subset corresponds to a first neural layer of the neural network model. In such implementations, the set of weight indices comprises indices corresponding to the selected first subset of the set of neural network weights.

In certain implementations, to train the neural network model, the processor 902 coupled with the memory 904 may be further configured to, capable of, or operable to cause the NE 900 to select a second subset of the set of neural network weights, where the second subset corresponding to a second neural layer of the neural network model. In such implementations, the set of weight indices further comprises indices corresponding to the selected second subset of the set of neural network weights.

In some further implementations, the first subset of the set of neural network weights is selected from a first set of candidate weight values associated with the first neural layer of the neural network model, and the second subset of the set of neural network weights is selected from a second set of candidate weight values associated with the second neural layer of the neural network model. In such implementations, the first set of candidate weight values and the second set of candidate weight values are based on the weight generator.

In certain implementations, the model generation information further indicates a first number of candidate weights in the first set of candidate weight values and a second number of candidate weights in the second set of candidate weight values. In certain implementations, the first number of candidate weights is different than the second number of candidate weights.

In some implementations, to train the neural network model, the processor 902 coupled with the memory 904 may be further configured to, capable of, or operable to cause the NE 900 to optimize an objective function based on the set of data samples.

In some implementations, the processor 902 coupled with the memory 904 may be configured to, capable of, or operable to cause the NE 900 to receive the set of data samples from the second wireless node or a third wireless node.

In some implementations, the processor 902 coupled with the memory 904 may be configured to, capable of, or operable to cause the NE 900 to determine the set of data samples based on one or more signals received from the second wireless node or a third wireless node.

Additionally, or alternatively, in some other implementations, the processor 902 and the memory 904 coupled with the processor 902 may be configured to cause the NE 900 to perform various functions (e.g., operations, signaling) of a second wireless node, in accordance with examples as disclosed herein. For example, the processor 902 coupled with the memory 904 may be configured to, capable of, or operable to cause the NE 900 to receive (i.e., from a first wireless node) model generation information associated with a set of model parameters, where the model generation information indicates a weights generator and a set of weight indices; generate a set of neural network weights based on the model generation information; and construct a neural network model, based on the set of neural network weights and the set of weight indices, where the set of weight indices corresponds to one or more weights selected from the set of neural network weights.

In some implementations, the processor 902 coupled with the memory 904 may be configured to, capable of, or operable to cause the NE 900 to determine a first subset of the set of neural network weights corresponding to weight selections for a first neural layer of the neural network model. In such implementations, the set of weight indices further comprises indices corresponding to the first subset of the set of neural network weights.

In certain implementations, the processor 902 coupled with the memory 904 may be configured to, capable of, or operable to cause the NE 900 to determine a second subset of the set of neural network weights corresponding to weight selections for a second neural layer of the neural network model. In such implementations, the set of weight indices further comprises indices corresponding to the second subset of the set of neural network weights.

In some further implementations, to construct the neural network model, the processor 902 coupled with the memory 904 may be configured to, capable of, or operable to cause the NE 900 to determine a first weight from the first subset of the set of weights based on the model generation information, the set of weight indices, and a number of candidate weights for the first set of candidate weight values.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

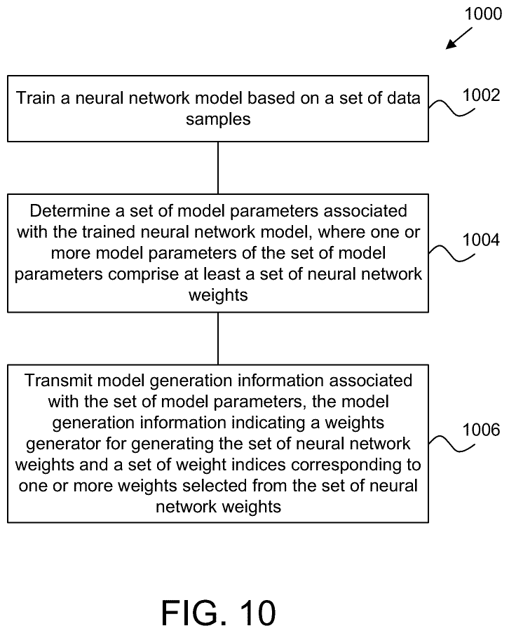

FIG. 10 illustrates a flowchart of a method 1000 in accordance with aspects of the present disclosure. The operations of the method 1000 may be implemented by a first wireless node as described herein. In some examples, the first wireless node may be implemented by a UE as described herein. Alternatively, the operations of the first wireless node may be implemented by a NE as described herein. In some implementations, the UE and/or NE may execute a set of instructions to control the function elements of the UE and/or NE to perform the described functions.

At step 1002, the method 1000 may include training a neural network model based on a set of data samples. The operations of step 1002 may be performed in accordance with examples as described herein. In some implementations, aspects of the operations of step 1002 may be performed by a UE, as described with reference to FIG. 7. In some other implementations, aspects of the operations of step 1002 may be performed by a NE, as described with reference to FIG. 9.

At step 1004, the method 1000 may include determining a set of model parameters associated with the trained neural network model, wherein one or more model parameters of the set of model parameters comprise at least a set of neural network weights. The operations of step 1004 may be performed in accordance with examples as described herein. In some implementations, aspects of the operations of step 1004 may be performed by a UE, as described with reference to FIG. 7. In some other implementations, aspects of the operations of step 1004 may be performed by a NE, as described with reference to FIG. 9.

At step 1006, the method 1000 may include transmitting, to a second wireless node, model generation information associated with the set of model parameters, wherein the model generation information indicates a weights generator for generating the set of neural network weights, and a set of weight indices corresponding to one or more weights selected from the set of neural network weights. The operations of step 1006 may be performed in accordance with examples as described herein. In some implementations, aspects of the operations of step 1006 may be performed by a UE, as described with reference to FIG. 7. In some other implementations, aspects of the operations of step 1006 may be performed by a NE, as described with reference to FIG. 9.

It should be noted that the method 1000 described herein describes one possible implementation, and that the operations and the steps may be rearranged or otherwise modified and that other implementations are possible.

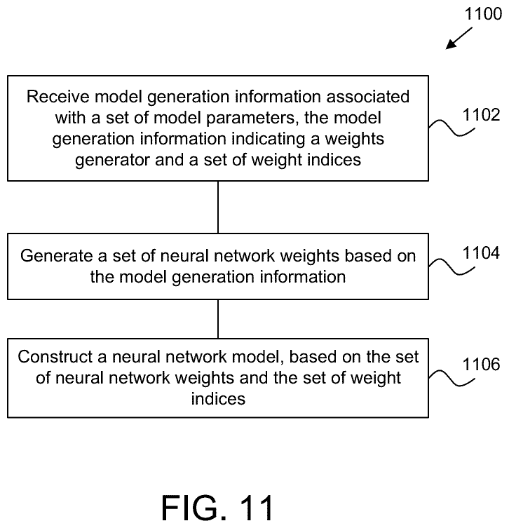

FIG. 11 illustrates a flowchart of a method 1100 in accordance with aspects of the present disclosure. The operations of the method 1100 may be implemented by a second wireless node as described herein. In some examples, the second wireless node may be implemented by a UE as described herein. Alternatively, the operations of the second wireless node may be implemented by a NE as described herein. In some implementations, the UE and/or NE may execute a set of instructions to control the function elements of the UE and/or NE to perform the described functions.

At step 1102, the method 1100 may include receiving, from a first wireless node, model generation information associated with a set of model parameters, wherein the model generation information indicates a weights generator and a set of weight indices. The operations of step 1102 may be performed in accordance with examples as described herein. In some implementations, aspects of the operations of step 1102 may be performed by a UE, as described with reference to FIG. 7. In some other implementations, aspects of the operations of step 1102 may be performed by a NE, as described with reference to FIG. 9.

At step 1104, the method 1100 may include generating a set of neural network weights based on the model generation information. The operations of step 1104 may be performed in accordance with examples as described herein. In some implementations, aspects of the operations of step 1104 may be performed by a UE, as described with reference to FIG. 7. In some other implementations, aspects of the operations of step 1104 may be performed by a NE, as described with reference to FIG. 9.

At step 1106, the method 1100 may include constructing a neural network model, based on the set of neural network weights and the set of weight indices, wherein the set of weight indices corresponds to one or more weights selected from the set of neural network weights. The operations of step 1106 may be performed in accordance with examples as described herein. In some implementations, aspects of the operations of step 1106 may be performed by a UE, as described with reference to FIG. 7. In some other implementations, aspects of the operations of step 1106 may be performed by a NE, as described with reference to FIG. 9.

It should be noted that the method 1100 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless node for wireless communication, comprising:
at least one memory; and
at least one processor coupled with the at least one memory and configured to cause the first wireless node to:
train a neural network model based on a set of data samples;
determine a set of model parameters associated with the trained neural network model, wherein one or more model parameters of the set of model parameters comprise at least a set of neural network weights; and
transmit, to a second wireless node, model generation information associated with the set of model parameters, wherein the model generation information indicates a weights generator for generating the set of neural network weights, and a set of weight indices corresponding to one or more weights selected from the set of neural network weights.

2. The first wireless node of claim 1, wherein the weights generator comprises a random number generator or a probability distribution, and wherein the model generation information further indicates a number of candidate weights in the set of neural network weights, one or more parameters of the probability distribution, or an initialization value for the random number generator, or a combination thereof.

3. The first wireless node of claim 1, wherein the neural network model comprises a plurality of neural layers, wherein each neural layer comprises one or more neurons of a plurality of neurons, and wherein each edge in a set of edges connects a respective neuron in one neural layer with another neuron in a successive neural layer, and wherein the neural network model comprises the plurality of neurons and the set of edges connecting the plurality of neurons.

4. The first wireless node of claim 1, wherein to train the neural network model, the at least one processor is configured to cause the first wireless node to select a first subset of the set of neural network weights, the first subset corresponding to a first neural layer of the neural network model, and wherein the set of weight indices comprises indices corresponding to the selected first subset of the set of neural network weights.

5. The first wireless node of claim 4, wherein to train the neural network model, the at least one processor is configured to cause the first wireless node to select a second subset of the set of neural network weights, the second subset corresponding to a second neural layer of the neural network model, and wherein the set of weight indices further comprises indices corresponding to the selected second subset of the set of neural network weights.

6. The first wireless node of claim 5, wherein the first subset of the set of neural network weights is selected from a first set of candidate weight values associated with the first neural layer of the neural network model, wherein the second subset of the set of neural network weights is selected from a second set of candidate weight values associated with the second neural layer of the neural network model, and wherein the first set of candidate weight values and the second set of candidate weight values are based on the weight generator.

7. The first wireless node of claim 6, wherein the model generation information further indicates a first number of candidate weights in the first set of candidate weight values and a second number of candidate weights in the second set of candidate weight values, and wherein the first number of candidate weights is different than the second number of candidate weights.

8. The first wireless node of claim 1, wherein the at least one processor is configured to cause the first wireless node to receive the set of data samples from the second wireless node or a third wireless node.

9. The first wireless node of claim 1, wherein the at least one processor is configured to cause the first wireless node to determine the set of data samples based on one or more signals received from the second wireless node or a third wireless node.

10. A method performed by a first wireless node, the method comprising:
training a neural network model based on a set of data samples;
determining a set of model parameters associated with the trained neural network model, wherein one or more model parameters of the set of model parameters comprise at least a set of neural network weights; and
transmitting, to a second wireless node, model generation information associated with the set of model parameters, wherein the model generation information indicates a weights generator for generating the set of neural network weights, and a set of weight indices corresponding to one or more weights selected from the set of neural network weights.

11. The method of claim 10, wherein the first wireless node comprises a user equipment (UE) or a base station.

12. A second wireless node for wireless communication, comprising:
at least one memory; and
at least one processor coupled with the at least one memory and configured to cause the second wireless node to:
receive, from a first wireless node, model generation information associated with a set of model parameters, wherein the model generation information indicates a weights generator and a set of weight indices;
generate a set of neural network weights based on the model generation information; and
construct a neural network model, based on the set of neural network weights and the set of weight indices, wherein the set of weight indices corresponds to one or more weights selected from the set of neural network weights.

13. The second wireless node of claim 12, wherein the weights generator comprises a random number generator or a probability distribution, and wherein the model generation information further indicates a number of candidate weights in the set of neural network weights, one or more parameters of the probability distribution, or an initialization value for the random number generator, or a combination thereof.

14. The second wireless node of claim 12, wherein the neural network model comprises a plurality of neural layers, wherein each neural layer comprises one or more neurons of a plurality of neurons, and wherein each edge in a set of edges connects a respective neuron in one neural layer with another neuron in a successive neural layer, and wherein the neural network model comprises the plurality of neurons and the set of edges connecting the plurality of neurons.

15. The second wireless node of claim 12, wherein a first subset of the set of neural network weights corresponds to weight selections for a first neural layer of the neural network model, and wherein the set of weight indices comprises indices corresponding to the first subset of the set of neural network weights.

16. The second wireless node of claim 15, wherein a second subset of the set of neural network weights corresponds to weight selections for a second neural layer of the neural network model, and wherein the set of weight indices further comprises indices corresponding to the second subset of the set of neural network weights.

17. The second wireless node of claim 16, wherein the first subset of the set of neural network weights is selected from a first set of candidate weight values associated with the first neural layer of the neural network model, wherein the second subset of the set of neural network weights is selected from a second set of candidate weight values associated with the second neural layer of the neural network model, and wherein the first set of candidate weight values and the second set of candidate weight values are based on the weight generator.

18. The second wireless node of claim 17, wherein the model generation information further indicates a first number of candidate weights in the first set of candidate weight values and a second number of candidate weights in the second set of candidate weight values, and wherein the first number of candidate weights is different than the second number of candidate weights.

19. The second wireless node of claim 17, wherein to construct the neural network model, the at least one processor is configured to cause the second wireless node to:
determine a first weight from the first subset of the set of weights based on the model generation information, the set of weight indices, and a number of candidate weights for the first set of candidate weight values.

20. A method performed by a second wireless node, the method comprising:
receiving, from a first wireless node, model generation information associated with a set of model parameters, wherein the model generation information indicates a weights generator and a set of weight indices;
generating a set of neural network weights based on the model generation information; and
constructing a neural network model, based on the set of neural network weights and the set of weight indices, wherein the set of weight indices corresponds to one or more weights selected from the set of neural network weights.
